(19) United States
(12) Patent Application Publication
(10) Pub. No.: US 2014/0356838 A1
(43) Pub. Date: Dec. 4, 2014

(54) Education Game Systems and Methods

(71) Applicant: NerdCoach, LLC, Wilton, CT (US)

(72) Inventors: Joseph Freimuth, Los Angeles, CA (US); Christopher Anthony, New York, NY (US)

(73) Assignee: NerdCoach, LLC

(21) Appl. No.: 14/296,184

(22) Filed: Jun. 4, 2014

Related U.S. Application Data
(60) Provisional application No. 61/830,998, filed on Jun. 4, 2013.

(51) Int. Cl. G09B 7/06

(52) U.S. Cl. CPC G09B 7/06
USPC 434/348

(57) ABSTRACT

The present disclosure provides education game systems and methods that display test problems including answer options, wherein the systems and methods enable a user to drag the answer options from the test problem to an answer receiving location to improve the user's test taking skills, thereby improving their overall score on standardized exams.

### CROSS-REFERENCE TO RELATED APPLICATIONS

This application incorporates by reference and claims priority to U.S. Provisional Application No. 61/830,998 filed on Jun. 4, 2013.

### BACKGROUND OF THE INVENTION

The present subject matter relates generally to systems and methods for electronic educational games.

Obtaining high scores on standardized tests is extremely important to a student's future. With the correct score, a student will have the opportunity to attend a variety of prestigious universities in preparation for a career path of their choosing. Examples of standardized tests include the Scholastic Aptitude Test (SAT), Medical College Admission Test (MCAT), Law School Admission Test (LSAT), Graduate Record Examination (GRE), and American College Testing (ACT), among others.

One factor which is thought to improve a student's performance on these tests is coaching or formal test preparation efforts. In fact, an entire test preparation industry has arisen to help students improve their scores on these exams. Traditional services include classroom-based courses, tutoring, stand-alone printed publications, computer based materials and online courses. Unfortunately, most of the current methods for preparing students for exams are costly, inefficient and inconvenient.

For example, many prep courses have a qualified instructor that provides students with an overview of the exam and some of the tools students need to increase their score. The instructors typically walk the students through various portions of the exam and provide a surface overview of testing strategies. Notwithstanding the benefits of these programs, courses alone may not be enough for students to reach their maximum score on the exam.

One-on-one tutoring is also suggested for students to supplement the prep courses. However, tutoring is both time consuming and expensive. In addition, students often receive the advice to take as many practice exams outside of the prep course as they can before the date of the test. However, taking a full practice exam is not always logistically possible. The practice exams may take up to two or three hours and require the student to find a quiet room with a desk for working problems on scratch paper. Students rarely have the time in their schedule to block off hours at a time to practice. Further, students often need to study in environments that are not necessarily conducive to a taking a practice exam or answering sample exam questions.

Further, the feedback received from those companies that offer sample exams and diagnostic feedback of the student's performance is typically simplistic. The feedback is usually defined from a conventional testing perspective and is merely based on the number of incorrect answers. Therefore, the simplistic diagnosis is reduced to recommending the student to review certain types of problems.

Many test prep courses fail to provide students with the specific skill sets to enable the students to succeed on the exam. Accordingly, there is a need for efficient and convenient education game systems and methods as described and claimed herein.

### BRIEF SUMMARY OF THE INVENTION

The present disclosure provides systems and methods for an educational game. Various examples of the system and method are provided herein.

The education game system disclosed herein provides an efficient, convenient, and inexpensive education game system that students may use to prepare for standardized tests. The education game system is more portable and convenient than conventional, printed test prep material. In addition, the exercises associated with the system do not require additional scrap paper to perform. Therefore, a student can take advantage of the time in between daily activities to conveniently practice test skills. Unlike the traditional test prep materials which focus on practicing sample problems and questions found on a standardized test, the system disclosed herein improves a student's performance by providing skill based exercises in a fun game-like format.

In an example, the educational game system includes a mechanism for dragging and dropping information into equations, boxes, or other labeled positions on a user interface. For example, the user interface may include a displayed word problem or geometric diagram, such as that used by standardized tests (e.g., SAT and ACT). The user must drag relevant information into the proper positions on the user interface to correctly answer or solve the problem displayed.

In an example, the system may evaluate a user's ability to understand and calculate ratios. The user interface may have a question displayed that includes “50,000 tons of sand are required to produce 25,000 barrels. How many tons are needed to produce 3,000 barrels?” Below the question, two obeli (division signs) are separated by an equal sign: ______=______. The user must use the touchscreen to pull down the numbers from the word problem into appropriate positions above and below the obeli, based on the relationship described in the question. In the example described above, the problem may be displayed as “50,000/25,000=x/3,000.” The user can fill in the “x” in the equation to solve the problem.

Of course it is understood that the drag and drop mechanism may be used in any number of problems and games presented by the system. For example, the drag and drop mechanism may be used in relation to problems that evaluate a user's ability to calculate averages. For example, the system may display a single obelus sign on the user interface. The user must then drag each number from the word problem that is to be averaged down into the numerator above the obelus. The user must then select the blank dominator below the obelus and manually entering the number of items in the numerator that are to be averaged. A keypad may be displayed to enter the denominator or various numerical options may be presented to the user from which the user may drag the appropriate number to the denominator to complete the problem. The average may be calculated by the user or produced by the system based on the numerator and denominator selected by the user.

The drag and drop option may also be used with problems pertaining to probability calculations. For example, a user may be prompted to drag and drop information from a word problem into a probability formula. The user may select the numerator of the number of desired outcomes and the denominator of a number of total potential outcomes.

The drag and drop mechanism may also be used in verbal problems. For example, a user may drag and drop specific components of a sentence into boxes or positions on the user interface that corresponds with the component's part of speech. A sentence may be displayed for the user to drag and drop the subject and verb into their corresponding labeled boxes on the user interface.

The gaming system may also include a coordinates game that enables a user to swipe the user interface displaying a graph in order to indicate a graphical representation of an equation displayed on the user interface. For example, the system may display an equation that the user must graph on an x,y coordinate plane displayed by the system. The system evaluates whether the user has swiped, and thereby graphed, the equation correctly. If the graph is incorrect, the system may display the correct graphical representation of the equation.

Often, to answer standardized test questions correctly a student must identify and connect modifiers to the objects the modifiers modify. The system may include a game wherein the user must select or drag the modifier to the object it modifies. When a user moves a modifier next to the object it modifies, the system may evaluate whether the user's selection is correct.

Students also need to be able to revise sentences to eliminate ambiguous pronouns in order to answer standardize test questions correctly. The system may include a game that trains users to identify pronouns and link the pronouns to their antecedents, or determine if the pronoun is ambiguous. For example, the system may display a sentence and the user must drag the pronouns to their antecedents. If a pronoun does not have a clear antecedent, the user may drag the pronoun to a box on the user interface that may be labeled “ambiguous antecedent.” The user receives points for correctly identifying the antecedent of the pronoun, or correctly identifying the pronoun as ambiguous.

Yet another important skill for students taking standardized tests includes eliminating unimportant information. The system may include a scrubbing out game that trains users to aggressively hunt and identify unimportant information and scrub the information away to reveal a sentence that is clean of unimportant information. A user may swipe the information away from the sentence in a scrubbing motion. For example, prepositional phrases of a sentence may be scrubbed away without removing the nouns and verbs. The user may be rewarded points for every prepositional phrase eliminated. In another example, a new sentence may not be displayed until every prepositional phrase of the previous sentence has been removed by the user.

Another important skill for successful test takers is the ability to identify various tenses in a sentence or paragraph. The system may include displaying a sentence that uses correct verb tenses. Under each verb, the system may display a selection for past, present, and future tenses. The user must identify the timeline of events on the user interface. For example, the user may select the verb the user wishes to draw and then uses his finger or stylus to draw a horizontal line for a progressively tense or a vertical line for either a perfect or simple tense. Each drawing the user makes on the timeline is displayed in the same color as the color of the verb to which the drawing corresponds. For example, the timeline of the sentence, “I had eaten lunch when my brother arrived,” may be represented by a vertical red and a vertical blue lines both identifying past tense, wherein the red line corresponds to the first verb and the blue line corresponds to the second verb. The timeline sentence of, “I was eating lunch when my brother arrived,” may be represented by red and blue lines, wherein the red line is horizontal and the blue line is vertical, wherein the red line corresponds to the first verb and the blue line corresponds to the second verb.

Yet another important skill for test takers is the ability to recognize subtle differences between various questions. The system may train a user to identify differences between two questions by displaying two questions on a user interface and prompting the user to select the difference between the two questions. For example, the system may display the following two questions, “1. Who is the tallest person in the class?” and “2. Who is the second tallest person in the class?” The user must select the word “second” because the word identifies the difference between the first and second question.

In order to simulate the cognitive process of reading a sentence, the system also provides complete sentences that stream across the user interface at varying depths, speeds, and sizes.

In an embodiment, the education game system includes a controller and a user interface in communication with and controlled by the controller, the user interface including a display and a gesture-receiving input mechanism. The system also includes a memory coupled to the controller, wherein the memory is configured to store program instructions executable by the controller.

In response to executing the program instructions, the controller is configured to display a test problem and at least one answer option through the display, wherein each answer option is displayed at an initial answer option location. One or more of the answer options corresponds to a related answer receiving location, wherein the related answer receiving location is selected from a plurality of answer receiving locations. The controller is also configured to receive, through the gesture-receiving input mechanism, a user gesture corresponding to a user instruction to move one of the answer options from the initial answer option location to one of the plurality of answer receiving locations.

The controller is further configured to display the movement of the answer option from the initial answer option location to one of the plurality of answer receiving locations. In addition, the controller is configured to activate a first indication if the answer option is moved to its related answer receiving location, and activate a second option if the final answer option is moved to an answer receiving location other than its related answer receiving location.

In an example, the gesture-receiving input mechanism is a touch screen and the user gesture is touch and drag. In another example, the gesture-receiving input mechanism is a motion capture device and the user gesture is a user's motion.

The controller may be further configured to access a database in communication with the controller, wherein the database includes a plurality of test problems and corresponding answer options.

The test problem may include a text sentence including at least one answer option, wherein the answer receiving location is positioned adjacent to text within the sentence. Alternatively, or in addition to, the test problem may include a text sentence including at least one answer option, wherein the at least one answer receiving location is positioned below the text sentence, and the answer receiving location is displayed as a labeled box. In such example, the user gesture includes moving the answer option from the text sentence to the labeled box. In an example, the labeled box corresponds to a part of speech.

In an example, the test problem is a mathematical problem. For example, the test problem may have a solution in the form of a fraction including a numerator and a denominator. In such example, the controller may be configured to display a first answer option and a second answer option below text of the test problem, wherein the first answer option corresponds to a first answer receiving location and the second answer option corresponds to a second answer receiving location. The first answer receiving location may correspond to the numerator and the second answer receiving location may correspond to the denominator.

In another example, the test problem is a mathematical problem having a solution in the form of a fraction including a numerator and a denominator, wherein the test problem includes text including a first answer option and a second answer option. The first answer option may correspond to a first answer receiving location and the second answer option may correspond to a second answer receiving location. The first answer receiving location may correspond to the numerator and the second answer receiving location may correspond to the denominator.

In an example, the activation of the first indication increases a correct score. Alternatively, or in addition to, the activation of the second indication increases an incorrect score. The first indication may include a visual display, a sound, such as a bell sound, or any other suitable indication. The second indication may include a visual display, a sound, such as a buzzer sound, or any other indication.

In an example, the controller is configured to provide a plurality of difficulty levels, wherein the controller determines the difficulty level associated with the test problem based on a score associated with the user, wherein the score is based on a prior user gesture.

An advantage of the present systems and methods is that the system may be accessible through a portable electronic device, such as an iPhone, such that a student may accomplish quality studying without the need for test-prep books or scratch paper.

A further advantage of the present systems and methods is providing a student with short study sessions that can be performed in between daily activities, such as during a student's commute.

Another advantage of the present system is providing specific exercises for the student to master to improve his or her score on a test.

Yet another advantage of the present system is that the system provides a fun learning environment by presenting the exercises in a game-like format.

Another advantage of the present system is providing feedback associated with a lacking skill set associated with the incorrect answers, rather than feedback associated with the problem type of the incorrect answers.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an example of an embodiment of the system disclosed herein.

FIG. 2 is a front view of an example of a display of a test problem, answer options, and answer receiving locations displayed on a user interface, wherein the answer options are displayed below the test problem.

FIG. 3 is a front view of an example of a display of a test problem, answer options, and answer receiving locations displayed on a user interface, wherein the answer options are displayed within the text of the test problem.

FIG. 4 is a front view of an example of a display of a test problem, wherein the answer options have been moved to answer receiving locations, disclosed herein on a user interface.

FIGS. 5A-5B are front views of examples of a display of a test problem and answer options, wherein the answer options have been moved to the answer receiving locations in FIG. 5B.

FIG. 6A is a front view of an example of a display verbal game including answer options contained within the text of the test problem.

FIG. 6B is a front view of an example of a display of a test problem, wherein the user has moved the answer options from FIG. 6A into answer receiving locations.

FIG. 7A is a front view of an example of a display of a test problem and an answer receiving location as a coordinate system, as disclosed herein on a user interface.

FIG. 7B is a front view of an example of a display of a test problem and an answer receiving location as a coordinate system, wherein the user has gestured to enter a graph of the test problem in the answer receiving space.

FIGS. 8A-8B are front views of examples of a display of a test problem and answer options within the text of the test problem, wherein a user gesture includes swiping the answer options out of the text of the test problem.

FIGS. 9A-9B are front views of examples of a display of a test problem including answer options and answer receiving space, wherein the user moves the answer options on a time line.

### DETAILED DESCRIPTION OF THE INVENTION

The educational game systems disclosed herein provide students with various skill-based exercises aimed at improving their scores on standardized tests. Unlike traditional test-prep materials that provide sample problems associated with standardized tests, the present system provides game-like exercises for students to develop specific skills that will improve their speed and accuracy on the exam.

Standardized exams often contain answer options within a test problem that, if recognized and arranged in an equation correctly by students, make a substantial improvement in their overall score. The writers of standardized exams place both relevant and irrelevant answer options within a test problem. Often the irrelevant answer options are included to purposefully confuse or take the student off track from the correct answer path. However, if a student can identify the relevant information and arrange the relevant information correctly in an equation, the student will succeed in the problem. Similarly, if a student can identify the irrelevant information and discard it, the student will have a better chance of succeeding in the problem.

The present educational game system enables students to drag and drop the relevant information from a test problem into an equation outline on a user interface, such as a touch screen of an electronic device. Students may select the relevant answer options generally by tapping on the image of the answer option and dragging it into the appropriate location within the equation. The system trains a student's mind to quickly filter distracting information from the relevant answer options, a skill that will enhance the overall score of their exam. In another example, the system enables a user to scrub or wipe away the irrelevant information from the test problem, enabling a student to only focus on the relevant information.

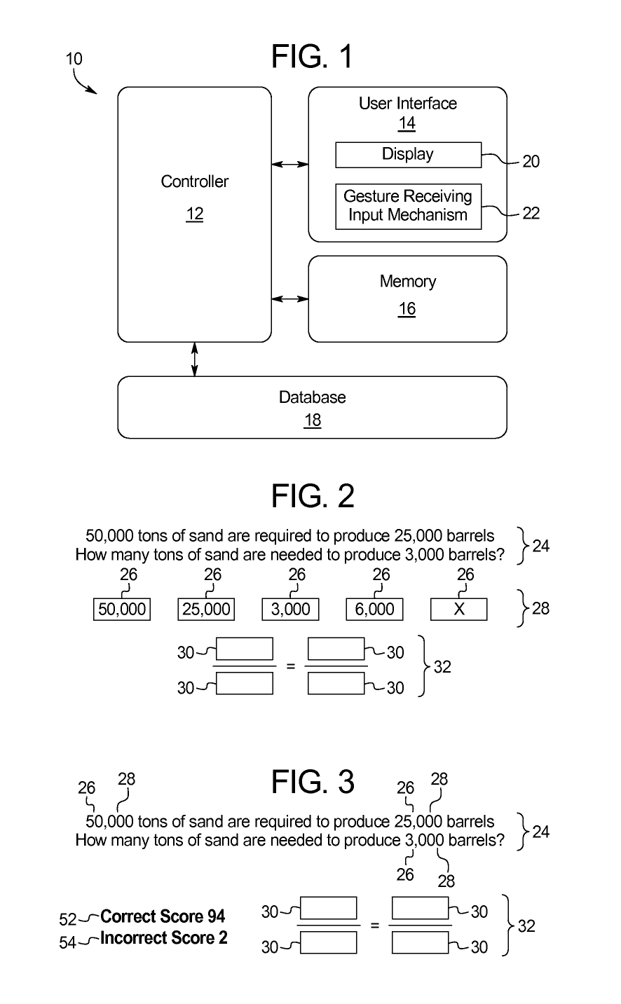

In an embodiment, the education game system 10 includes a controller 12 and a user interface 14 in communication with and controlled by the controller 12, wherein the user interface 14 includes a display 20 and a gesture-receiving input mechanism 22, as shown in FIG. 1. The system 10 also includes a memory 16 coupled to the controller 12, wherein the memory 16 is configured to store program instructions executable by the controller 12.

The gesture-receiving input mechanism 22 may be any suitable user action input mechanism. In an example, the gesture-receiving input mechanism 22 is a touch screen and the user gesture is touch and drag. In another example, the gesture-receiving input mechanism 22 is a motion capture device and the user gesture is a user's motion. In such example, the user may not actually touch the touch screen, but rather move such that the gesture-receiving input mechanism 22 recognizes movement of the user. Of course, the gesture-receiving input mechanism 22 may be any suitable selection mechanism that enables a user to select an answer. In yet another example, the gesture-receiving input mechanism 22 may include a touch screen and the user gesture may be typing in an answer selection from a displayed keyboard on the user interface 14.

In response to executing the program instructions, the controller 12 is configured to display a test problem 24 and at least one answer option 26 through the display 20, wherein each answer option 26 is displayed at an initial answer option location 28. The controller 12 may be further configured to access a database 18 in communication with the controller 12, wherein the database 18 includes a plurality of test problems 24 and corresponding answer options 26.

As shown in FIG. 2, the test problem 24 is a mathematical problem directed to solving a ratio question. The test problem 24 contains information to solve the problem. Of course, the test problem 24 may be any suitable problem including a mathematical, verbal, scientific, grammar, or any other subject matter. In an example, the test problems 24 are similar to test questions found on standardized tests, such as the SAT or ACT. The answer options 26 may include both relevant and irrelevant answer options 26.

The initial answer option location 28 may be within the text of the test problem 24 or displayed separately below the test problem 24. For example, in FIG. 2, the answer options 26 are displayed below the test problem 24, wherein each answer option 26 has a specific initial answer option location 28. In FIG. 2, initial answer option location 28 of the answer options 26 are displayed below the test problem 24. In contrast, in FIG. 3, the initial answer option location 28 of the answer options 26 are positioned within the text of the test problem 24.

One or more of the answer options 26 correspond to a related answer receiving location 30, wherein the related answer receiving location 30 is selected from a plurality of answer receiving locations 32. In other words, at least one answer option 26 has a corresponding correct answer receiving location 30. The plurality of answer receiving locations 32 may be in any suitable arrangement including mathematical equations, grammatical structures, sentence structures, and coordinate systems, among others.

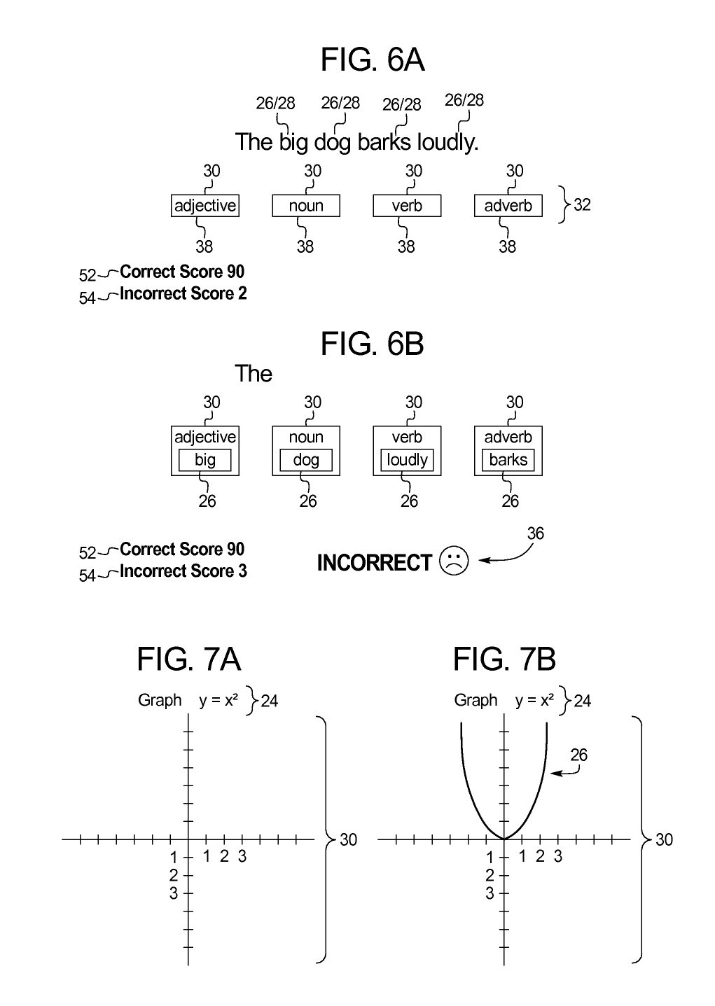

As shown in FIGS. 2-3, the plurality of answer receiving locations 32 are arranged in an equation structure, wherein the user can match answer options 26 to an answer receiving location 30. In FIGS. 6A-6B, the plurality of answer receiving locations 32 are also displayed below the test problem 26 and arranged in the form of labeled boxes 38. In addition, FIGS. 7A-7B include an answer receiving locations 30 include a coordinate system or graph area.

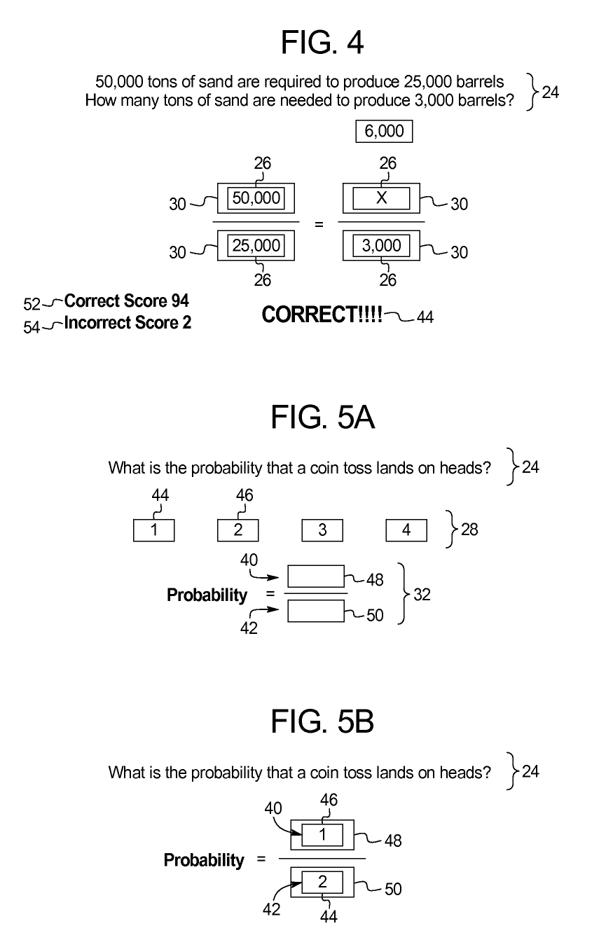

The controller 12 is configured to receive, through the gesture-receiving input mechanism 22, a user gesture corresponding to a user instruction to move one of the answer options 26 from the initial answer option location 28 to one of the plurality of answer receiving locations 32. For example, as discussed above, the user gesture may be dragging the displayed answer option 26 and dropping the answer option 26 into one of the plurality of answer receiving locations 32. For example, FIG. 4 is an example of a display wherein the user has moved the answer options 26 into the plurality of answer options 32. In such example, the controller 12 is further configured to display the continuous movement of the answer option 26 from the initial answer option location 28 to one of the plurality of answer receiving locations 32. In another example, the user gesture may swipe or draw on the user interface 14 to graph a mathematical equation, as shown in FIGS. 7A-7B.

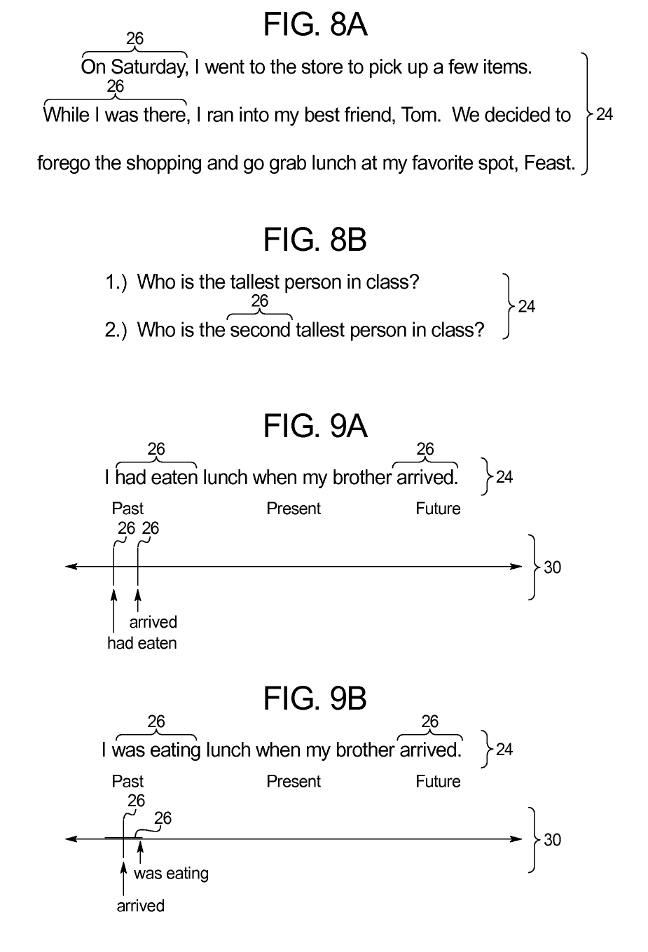

The user gesture may also be swiping away irrelevant information from a test problem 24. In such examples as shown in FIGS. 8A-8B, the answer receiving location 30 may be outside of the text of the test problem 24. For example, in FIG. 8A, the test problem 24 includes both relevant and irrelevant information. The irrelevant information may be the answer options 26, such that the user gesture includes swiping the answer options 26 away from the test problem 24. As mentioned above, successful test takers are able to identify irrelevant information and disregard the irrelevant information as the test taker proceeds in answering the test problem 24. As such, the system 10 includes a game that enables users to identify and remove irrelevant information, as answer options 26, in order produce a test problem 24 that is free of irrelevant information. In FIG. 8A, the answer options 26 are irrelevant information in the form of, for example, prepositional phrases.

In FIG. 8B, the user is prompted to swipe away an answer option 26 that corresponds to identifying the difference between the first question and second question displayed. In FIG. 8B, the difference between the first question and second question is the word “second.” Again, successful test takers must be able to quickly identify key words within a test problem 24 in order to correctly answer the test problem 24. The system 10 enables students to practice the skill of identifying important key words that are essential to recognize in order to correctly answer the test problems 24.

In addition, the controller 12 is configured to activate a first indication 44, if the answer option 26 is moved to its related answer receiving location 30. The controller 12 is configured to activate a second indication 36 if the answer option 26 is moved to an answer receiving location other than its related answer receiving location 30. The first indication 34 may include a visual display, a sound, such as a bell sound, or any other suitable indication. Similarly, the second indication 36 may include a visual display, a sound, such as a buzzer sound, or any other indication.

In an example, the activation of the first indication 34 increases a correct score 52, as shown in FIGS. 3-4. Alternatively, or in addition to, the activation of the second indication 36 increases an incorrect score 54, as shown in FIGS. 6A-6B.

In yet another example, the controller 12 is configured to provide a plurality of difficulty levels, wherein the controller 12 determines the difficulty level associated with the test problem 24 based on a score associated with the user, wherein the score is based on a prior user gesture. For example, as the user's correct score 52 increases, the difficulty level increases. In contrast, for example, as the user's incorrect score 54 increases, the difficulty level may decrease.

In the example in FIGS. 3-4, the user has correctly matched the answer options 26 to their related answer receiving locations 30. As a result, the controller 12 activates a first indication 34, which, in the example, in addition to increasing the correct score 52 includes a visual display of the word “Correct.” Alternatively, as shown in FIG. 6B, the answer options 26 are not matched with their related answer receiving locations 30, and as a result the second indication 36 may include a display of “Incorrect.”

The test problem 24 may include a text sentence including at least one answer option 26, wherein the answer receiving location 30 is positioned adjacent to text within the sentence. For example, the test problem 24 may include a sentence that includes at least one noun, at least one verb, and various modifiers. The answer options 26 may be the modifiers, and the user gesture may include selecting and moving the answer options 26 adjacent to the noun or verb that the answer option 26 is modifying. As such the plurality of the answer receiving locations 32 may be adjacent to the noun and verb.

Alternatively, or in addition to, the test problem 24 may include a text sentence including at least one answer option 26, wherein the at least one answer receiving location 20 is positioned below the text sentence, and the answer receiving location 20 is displayed as a labeled box 38, as shown in FIGS. 6A-6B. In such example, the user gesture includes moving the answer option 26 from the text sentence to the labeled box 38. In an example, the labeled box 38 corresponds to a part of speech. As shown in FIGS. 6A-6B, the test problem 24 includes a sentence including answer options 26 at initial answer option locations 28. The plurality of answer receiving locations 32 include labeled boxes 38 indicating parts of speech. The user gesture includes dragging the words (answer options 26) from the sentence into the appropriate labeled box 38. As shown in FIG. 6B, the user gesture did not correctly match every answer option 26 with the related answer receiving space 30. As a result, a second indication may be activated, such as the display of “Incorrect,” as shown in FIG. 6B.

In an example, the test problem 24 may have a solution in the form of a fraction including a numerator 40 and a denominator 42, as shown in FIGS. 5A-5B. In such example, the controller 12 may be configured to display a first answer option 44 and a second answer option 46 below text of the test problem 24, wherein the first answer option 44 corresponds to a first answer receiving location 48 and the second answer option 46 corresponds to a second answer receiving location 50. The first answer receiving location 48 may correspond to the numerator 40 and the second answer receiving location 50 may correspond to the denominator 42. As shown in FIGS. 5A-5B, the first answer option 44 corresponds to the first answer receiving location 48, which corresponds to a numerator 40. Similarly, the second answer option 46 corresponds to the second answer receiving location 50, which corresponds to the denominator 42.

In another example, the test problem 24 is a mathematical problem having a solution in the form of a fraction including a numerator 40 and a denominator 42. The test problem 24 may include text including a first answer option 44 and a second answer option 46. In other words, instead of the first answer option 44 and second answer option 46 being displayed below the test problem 24, as shown in FIGS. 5A-5B, the first answer option 44 and second answer option 46 may only be displayed in the text of the test problem 24. In such example, the user gesture moves the first answer option 44 and second answer option 46 to their respective answer receiving locations, 48 and 50.

As shown in FIGS. 9A-9B, the user must identify the timeline of events on the user interface 14. For example, the user may select the answer option 26, a verb in this example, the user wishes to draw and then uses his finger or stylus to draw a horizontal line for a progressively tense or a vertical line for either a perfect or simple tense. Each drawing (user gesture) the user makes on the timeline is displayed in the same color as the color of the verb to which the drawing corresponds.

For example, as shown in FIG. 9A, the timeline of the sentence, “I had eaten lunch when my brother arrived,” may be represented by a vertical red and a vertical blue lines both identifying past tense, wherein the red line corresponds to the first verb and the blue line corresponds to the second verb. As shown in FIG. 9B, the timeline sentence of, “I was eating lunch when my brother arrived,” may be represented by red and blue lines, wherein the red line is horizontal and the blue line is vertical, wherein the red line corresponds to the first verb and the blue line corresponds to the second verb.

The system 10 may also provide a reward payout based on a user's performance. The rewards create an incentive for the user to continue to study and work towards abstract goals. The source of the money for the rewards may be from the user or a donor who places money into a study trust.

The rewards may be paid to the user upon completion of certain tasks. Such tasks may include quizzes, problem sets, full-length exams, or after obtaining a sufficient score in any a particular problem set or evaluation. The amount of money paid out to the user may be based on the user's performance of the task. For example, the user would receive a higher reward for a higher score, and a lower reward for a lower score.

Although the description thus far has indicated a visual format of producing questions and receiving answers from a user, it is contemplated that the system 10 may be configured to verbally ask the user questions in order to help the user prepare for standardized tests. The system 10 is also configured to receive oral answers from the user using voice commands. Therefore, the system 10 enables a user to study while driving or doing any other task that requires his or her hands.

As shown in FIG. 1, aspects of the systems and methods described herein are controlled by one or more controllers 12. The one or more controllers 12 may be adapted to run a variety of application programs, access and store data, including accessing and storing data in associated databases 18, and enable one or more interactions as described herein. Typically, the one or more controllers 12 are implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memory 16 and an interconnect bus. The CPU may contain a single microprocessor, or it may contain a plurality of microprocessors for configuring the CPU as a multi-processor system. The memory 16 include a main memory, such as a dynamic random access memory (DRAM) and cache, as well as a read only memory, such as a PROM, EPROM, FLASH-EPROM, or the like. The system may also include any form of volatile or non-volatile memory 16. In operation, the memory 16 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller 12. For example, the one or more controllers 12 may include a graphics subsystem to drive the output mechanism. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and device may be provided based on various combinations of the features and functions from the subject matter provided herein.

We claim:

1. An education game system comprising:
a controller;
a user interface in communication with and controlled by the controller, the user interface including a display and a gesture-receiving input mechanism; and
a memory coupled to the controller, wherein the memory is configured to store program instructions executable by the controller and, in response to executing the program instructions, the controller is configured to:
display a test problem and at least one answer option through the display, wherein each answer option is displayed at an initial answer option location, wherein one or more of the answer options corresponds to a related answer receiving location, wherein the related answer receiving location is selected from a plurality of answer receiving locations;
receive, through the gesture-receiving input mechanism, a user gesture corresponding to a user instruction to move one of the answer options from the initial answer option location to one of the plurality of answer receiving locations;
display the movement of the answer option from the initial answer option location to one of the plurality of answer receiving locations;
activate a first indication if the answer option is moved to its related answer receiving location; and
activate a second indication if the answer option is moved to an answer receiving location other than its related answer receiving location.

2. The system of claim 1 wherein the gesture-receiving input mechanism is a touch screen and the user gesture is touch and drag.

3. The system of claim 1 wherein the gesture-receiving input mechanism is a motion capture device and the user gesture is a user's motion.

4. The system of claim 1 wherein the controller is further configured to access a database in communication with the controller, wherein the database includes a plurality of test problems and corresponding answer options.

5. The system of claim 1 wherein the test problem includes a text sentence including at least one answer option, wherein the answer receiving location is positioned adjacent to text within the sentence.

6. The system of claim 1 wherein the test problem includes a text sentence including at least one answer option, wherein the at least one answer receiving location is positioned below the text sentence, wherein the answer receiving location is displayed as a labeled box, wherein the user gesture includes moving the answer option from the text sentence to the labeled box.

7. The system of claim 6 wherein the labeled box corresponds to a part of speech.

8. The system of claim 1 wherein the test problem is a mathematical problem.

9. The system of claim 1 wherein the test problem is a mathematical problem having a solution in the form of a fraction including a numerator and a denominator,
wherein the controller is configured to display a first answer option and a second answer option below text of the test problem, wherein the first answer option corresponds to a first answer receiving location and the second answer option corresponds to a second answer receiving location, wherein the first answer receiving location corresponds to the numerator and the second answer receiving location corresponds to the denominator.

10. The system of claim 1 wherein the test problem is a mathematical problem having a solution in the form of a fraction including a numerator and a denominator, wherein the test problem includes text including a first answer option and a second answer option, wherein the first answer option corresponds to a first answer receiving location and the second answer option corresponds to a second answer receiving location, wherein the first answer receiving location corresponds to the numerator and the second answer receiving location corresponds to the denominator.

11. The system of claim 1 wherein the activation of the first indication increases a correct score.

12. The system of claim 1 wherein the activation of the second indication increases an incorrect score.

13. The system of claim 1 wherein the first indication comprises a visual display.

14. The system of claim 1 wherein the second indication comprises a visual display.

15. The system of claim 1 wherein the first indication comprises a bell sound.

16. The system of claim 1 wherein the second indication comprises a buzzer sound.

17. The system of claim 1 wherein the controller is configured to provide a plurality of difficulty levels, wherein the controller determines the difficulty level associated with the test problem based on a score associated with the user, wherein the score is based on a prior user gesture.
